(19) United States
(12) Patent Application Publication
(10) Pub. No.: US 2025/0286644 A1
(43) Pub. Date: Sep. 11, 2025

(54) OPTICAL CHANNEL MONITOR ASSISTED BY A SWITCHING ENGINE

(71) Applicant: Lumentum Operations LLC, San Jose, CA (US)

(72) Inventors: Josh P. KEMP, Ottawa (CA); Shane H. WOODSIDE, Ottawa (CA); David J. DOUGHERTY, Mountain View, CA (US); Paul Dwight COLBOURNE, Ottawa (CA)

(21) Appl. No.: 18/759,090

(22) Filed: Jun. 28, 2024

Related U.S. Application Data
(60) Provisional application No. 63/561,501, filed on Mar. 5, 2024.

(51) Int. Cl. H04J 14/02

(52) U.S. Cl. CPC H04J 14/0212

(57) ABSTRACT

Some implementations relate to an optical channel monitor. The optical channel monitor may include a dispersive element positioned in an optical path of an optical signal, the dispersive element to separate the optical signal into dispersed wavelength channels. The optical channel monitor may include a switching engine positioned in optical paths of the dispersed wavelength channels, the switching engine to guide one or more subsets of wavelength channels of the optical signal. The optical channel monitor may include a tunable filter to scan through respective wavelength channels of the one or more subsets of wavelength channels of the optical signal.

### CROSS-REFERENCE TO RELATED APPLICATION

This Patent Application claims priority to U.S. Provisional Patent Application No. 63/561,501, filed on Mar. 5, 2024, and entitled “SWITCHING ENGINE ASSISTED SILICON PHOTONICS OPTICAL CHANNEL MONITOR.” The disclosure of the prior Application is considered part of and is incorporated by reference into this Patent Application.

### TECHNICAL FIELD

The present disclosure relates generally to optical networks and to an optical channel monitor assisted by a switching engine.

### BACKGROUND

An optical channel monitor (OCM) is a device capable of measuring an optical power in a wavelength channel of an optical signal. An OCM can be connected to a point in an optical network in order to measure, for example, power, frequency, and other characteristics of an optical channel at that point. In some cases, an OCM may scan multiple wavelength channels in order to measure optical power in the multiple channels (e.g., across a range of wavelengths). For example, an OCM may be used to monitor channels in a wavelength division multiplexed (WDM) system in which wavelength channels are multiplexed into a common carrier signal for transmission across the optical network (e.g., a dense wavelength division multiplexed (DWDM) system in which wavelength channels are spaced apart by a frequency of 50 gigahertz (GHz), among other examples).

### SUMMARY

Some implementations relate to an optical device combining a wavelength selective switch and an optical channel monitor. The optical device may include a first port group, for wavelength-division switching, including a first input port to launch a first optical signal. The optical device may include a second port group, for optical channel monitoring, including a second input port to launch a second optical signal. The optical device may include a dispersive element positioned in optical paths of the first optical signal and the second optical signal, the dispersive element to separate the first optical signal and the second optical signal into dispersed wavelength channels. The optical device may include a switching engine positioned in optical paths of the dispersed wavelength channels, the switching engine to guide one or more wavelength channels of the first optical signal to respective output ports of the first port group, and guide one or more subsets of wavelength channels of the second optical signal to an output port of the second port group. The optical device may include a tunable filter to scan through respective wavelength channels of the one or more subsets of wavelength channels of the second optical signal.

Some implementations relate to an optical channel monitor. The optical channel monitor may include a dispersive element positioned in an optical path of an optical signal, the dispersive element to separate the optical signal into dispersed wavelength channels. The optical channel monitor may include a switching engine positioned in optical paths of the dispersed wavelength channels, the switching engine to guide one or more subsets of wavelength channels of the optical signal. The optical channel monitor may include a tunable filter to scan through respective wavelength channels of the one or more subsets of wavelength channels of the optical signal.

In some implementations, a method includes guiding, by a switching engine of an optical device, one or more subsets of wavelength channels of an optical signal to a tunable filter of the optical device, and scanning, by the tunable filter, through respective wavelength channels of the one or more subsets of wavelength channels of the optical signal.

### BRIEF DESCRIPTION OF THE DRAWINGS

FIG. 1 is a diagram illustrating an example of an optical device.

FIG. 2 is a diagram illustrating an example of an optical device.

FIG. 3A is a diagram illustrating an example optics system that can be used in an optical device.

FIGS. 3B-3D are diagrams illustrating example tunable filters.

FIG. 4 is a diagram illustrating an example ring filter.

FIG. 5 is a flowchart of an example process associated with optical channel monitoring.

### DETAILED DESCRIPTION

The following detailed description of example implementations refers to the accompanying drawings. The same reference numbers in different drawings may identify the same or similar elements.

An optical channel monitor (OCM) may be utilized in an optical network to measure characteristics relating to wavelength channels used in the optical network. An OCM that is equipped to handle fast and efficient monitoring of multiple wavelength channels may have a complex design, and therefore may be expensive. In some examples, an OCM may be combined with a wavelength selective switch (WSS) to provide fast scanning through wavelength channels using a switching engine. A scanning speed for the OCM may be dependent on a switching speed of the switching engine. However, simple switching engines are generally associated with insufficient switching speeds to support an OCM, whereas switching engines with sufficient switching speeds to support an OCM may add excessive complexity and are high cost.

Some implementations described herein relate to an optical device that combines a WSS and an OCM. In some implementations, the optical device includes a switching engine and a tunable filter. The switching engine may sequentially guide multiple filtered subsets of dispersed wavelength channels of an optical signal to the tunable filer. For example, a first subset may include a first interleave spectrum (e.g., with odd-numbered wavelength channels), and a second subset may include a second interleave spectrum (e.g., with even-numbered wavelength channels). The tunable filter may scan through respective wavelength channels of each filtered subset of wavelength channels, and the respective wavelength channels can be measured in connection with optical channel monitoring.

The switching engine may be able to filter wavelength channels with high precision, but at relatively slow switching speeds. Accordingly, various low-complexity and low-cost switching engines may be used in the optical device. Inversely, the tunable filter may be associated with fast switching speeds, but may have relatively low filtering precision compared to the switching engine. Thus, the tunable filter also may be associated with low complexity and low cost. For example, the tunable filter may be a silicon photonics (SiP) filter. The switching engine can be used to precisely pre-filter a total spectrum into several filtered spectra with spacing between wavelength channels that are suitable for the tunable filter to quickly scan without the need for high precision (e.g., due to the spacing between wavelength channels).

Thus, combining the precise filtering of the switching engine with the high-speed scanning of the tunable filter achieves an OCM that is precise, fast, and low cost.

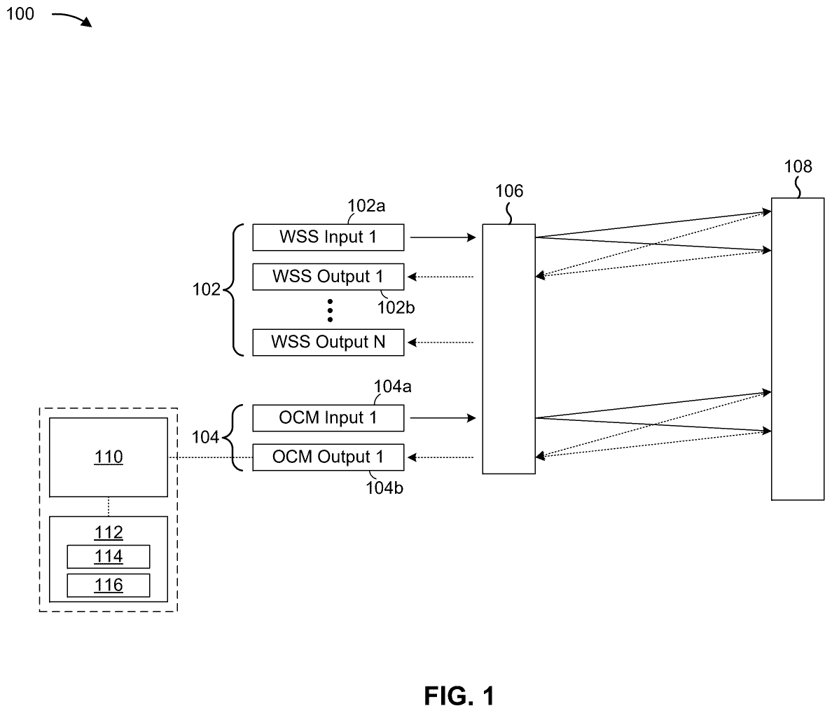

FIG. 1 is a diagram illustrating an example of an optical device 100. The optical device 100 includes a WSS and/or an OCM. For example, the optical device 100 implements a combination of a WSS and an OCM. As shown, the optical device 100 may include a first port group 102, a second port group 104, a dispersive element 106, a switching engine 108, a tunable filter 110, and/or a monitoring element 112.

The first port group 102 may be used for wavelength-division switching. For example, the first port group 102 may be used for the WSS of the optical device 100. Accordingly, the first port group 102 may be referred to herein as the “WSS port group 102,” and a port of the first port group 102 may be referred to herein as a “WSS port.” The second port group 104 may be used for optical channel monitoring. Accordingly, the second port group 104 may be referred to herein as the “OCM port group 104,” and a port of the second port group 104 may be referred to herein as an “OCM port.” The WSS port group 102 (e.g., for WSS operations of the optical device 100) and the OCM port group 104 (e.g., for OCM operations of the optical device 100) may use respective optical paths (e.g., twin paths) of the optical device 100, but may share the same optics system (e.g., the dispersive element 106 and the switching engine 108) of the optical device 100. Alternatively, the WSS port group 102 and the OCM port group 104 may use respective optics systems (e.g., respective sets of dispersive elements and switching engines). The WSS port group 102 and the OCM port group 104 may be included in the same port array (e.g., the same physical unit) or in respective port arrays.

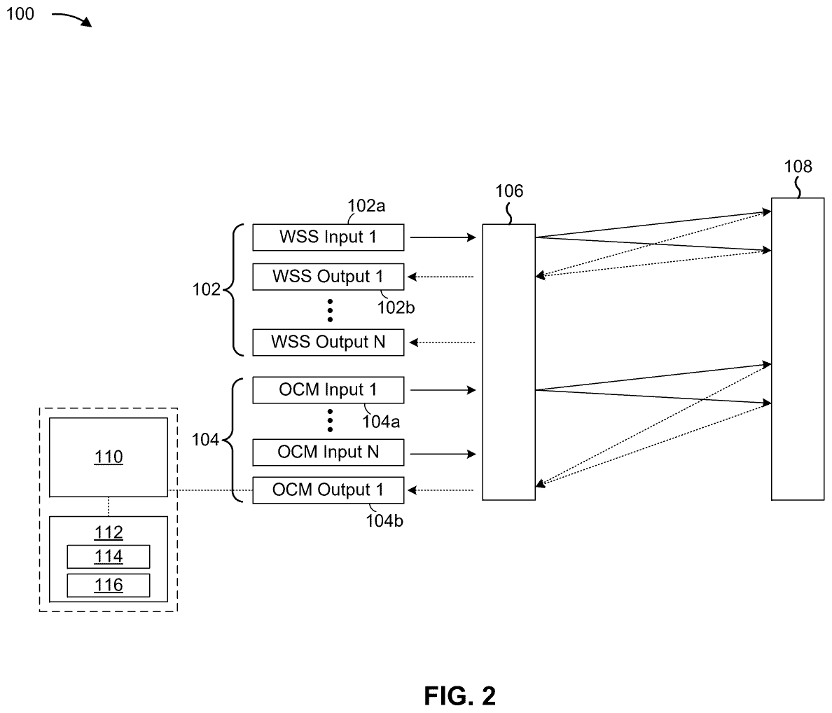

The WSS port group 102 may include a WSS input port 102a and multiple WSS output ports 102b, shown as WSS output ports 1 through N, where N is an integer greater than or equal to 2. Similarly, the OCM port group 104 may include an OCM input port 104a and an OCM output port 104b. In some implementations, the OCM input port 104a may be one of a plurality of OCM input ports 104a of the OCM port group 104, as described in connection with FIG. 2. In some implementations, WSS ports 102a, 102b of the WSS port group 102 and OCM ports 104a, 104b of the OCM port group 104 are optically coupled to optical fibers and/or waveguides (not shown). For example, the WSS input port 102a and the OCM input port 104a may be optically coupled to respective input fibers, and the WSS output ports 102b and the OCM output port 104b may be optically coupled to respective output fibers.

The WSS input port 102a may launch a first optical signal (e.g., that is being carried by an input optical fiber) into the optics system of the optical device 100. The first optical signal may be referred to herein as the “WSS optical signal.” Similarly, the OCM input port 104a may launch a second optical signal (e.g., that is being carried by an input optical fiber) into the optics system of the optical device 100. The second optical signal may be referred to herein as the “OCM optical signal.” The WSS optical signal and the OCM optical signal each may be wavelength-division multiplexed signals. The WSS optical signal and the OCM optical signal may be split from the same original signal, or the WSS optical signal and the OCM optical signal may be different signals.

The dispersive element 106 may include an element to separate a beam of light into dispersed wavelength channel sub-beams, and combine (e.g., converge) groups of dispersed wavelength channel sub-beams, based on wavelength. In particular, in a forward direction of light propagation, the dispersive element 106 may be capable of separating (e.g. spreading or angular diverging) a beam of light (e.g., an input beam launched by the WSS input port 102a or the OCM input port 104a) into multiple sub-beams, each carrying a wavelength channel of the beam that includes one or more wavelengths in a particular range of wavelengths. In a reverse direction of light propagation, the dispersive element 106 may be capable of combining (e.g. angular converging) groups of dispersed wavelength channel sub-beams to form wavelength-division multiplexed signals (e.g., each including one or more dispersed wavelength channel sub-beams). In some implementations, the dispersive element 106 may include diffractive optics. The dispersive element 106 may include a diffraction grating, a prism, an Echelle grating, or a grism, among other examples.

The WSS input port 102a may launch the WSS optical signal, and the OCM input port 104a may launch the OCM optical signal, into the dispersive element 106. For example, the dispersive element 106 may be positioned in optical paths of the WSS optical signal and the OCM optical signal. The dispersive element 106 may separate the WSS optical signal and the OCM optical signal into wavelength channels (e.g., sub-beams). That is, the dispersive element 106 may separate the WSS optical signal into a first plurality of wavelength channels, and separate the OCM optical signal into a second plurality of wavelength channels.

The switching engine 108 may include a switching array of switching elements for independent routing of dispersed wavelength channels. Each dispersed wavelength channel may be incident on a different switching element of the switching engine 108. Each switching element of the switching engine 108 may steer (e.g., based on an angle of the switching element) a respective dispersed wavelength channel. The switching engine 108 may include a digital light processor (DLP) switching engine (e.g., that uses a digital micromirror device), a liquid crystal on silicon (LCOS) switching engine, a micro-electrical-mechanical system (MEMS) mirrors switching engine (e.g., using an array of tiltable MEMS mirrors), or a stack of liquid crystal cells and birefringent prisms, among other examples.

The switching engine 108 may be positioned in optical paths of the dispersed wavelength channels from the dispersive element 106. The switching engine 108 may guide (e.g., steer) wavelength channels of the WSS optical signal to respective WSS output ports 102b (e.g., one wavelength channel per WSS output port 102b or multiple wavelength channels per WSS output port 102b). Furthermore, the switching engine 108 may guide (e.g., steer) one or more subsets (e.g., proper subsets) of wavelength channels of the OCM optical signal to the tunable filter 110 via the OCM output port 104b. For example, the switching engine 108 may guide a subset of wavelength channels (e.g., a filtered spectrum) to the tunable filter 110 (e.g., via the OCM output port 104b), while blocking (e.g., transmitting or absorbing rather than reflecting, reflecting elsewhere, or the like) a remainder of the wavelength channels. A subset of wavelength channels may include any number of wavelength channels that is less than all of the dispersed wavelength channels (e.g., a sub-division of the entire spectrum); however, in some examples, the switching engine 108 may guide a set of all of the wavelength channels of the OCM optical signal to the tunable filter 110 (e.g., to facilitate measurement of total optical power, or measurement of light present at the boundaries between wavelength channels).

To enable this blocking, while also facilitating monitoring of all of the dispersed wavelength channels of the OCM optical signal, the switching engine 108 may sequentially alter a spectrum guided to the tunable filter 110 (e.g., via the OCM output port 104b). For example, the totality of dispersed wavelength channels may be subdivided into multiple subsets of wavelength channels (e.g., where each subset has less than all of the dispersed wavelength channels). Each subset of wavelength channels may be different from any other subset of wavelength channels (e.g., differ by at least one wavelength channel). For example, each subset of wavelength channels may have no common wavelength channels with any other subset of wavelength channels (e.g., the subsets of wavelength channels may be distinct sub-divisions of the entire spectrum, which may be divided according to a pattern or a configuration). For example, the combination of the multiple subsets of wavelength channels may include all of the dispersed wavelength channels (e.g., the entire spectrum).

As an example, the switching engine 108 may guide a first subset of wavelength channels (e.g., a first spectrum) to the tunable filter 110 (e.g., via the OCM output port 104b) while blocking a second subset of wavelength channels (e.g., a second spectrum). Continuing with the example, sequentially to guiding the first subset of wavelength channels, the switching engine 108 may guide the second subset of wavelength channels to the tunable filter 110 (e.g., via the OCM output port 104b) while blocking the first subset of wavelength channels. Sequential guiding in this manner may be performed using any number of subsets of wavelength channels.

In some implementations, a subset of wavelength channels may include a pattern or a configuration of wavelength channels that is based on one or more characteristics of the tunable filter 110 (e.g., a precision of the tunable filter 110, a switching speed of the tunable filter 110, or the like). In some implementations, a subset of wavelength channels may have spacings between each of the included wavelength channels in the subset. For example, the multiple subsets of wavelength channels may include two or more interleave spectra to reduce adjacent-channel crosstalk at the tunable filter 110. As an example, the switching engine 108 may guide a first interleave spectrum (e.g., with odd-numbered wavelength channels) to the tunable filter 110 while blocking a second interleave spectrum (e.g., with even-numbered wavelength channels). Continuing with the example, the switching engine 108 may then guide the second interleave spectrum to the tunable filter 110 while blocking the first interleave spectrum. An interleave spectrum may include wavelength channels that alternate in a frequency domain with the wavelength channels of another interleave spectrum. In this way, the switching engine 108 provides pre-filtering of the dispersed wavelength channels before the filtering performed by the tunable filter 110.

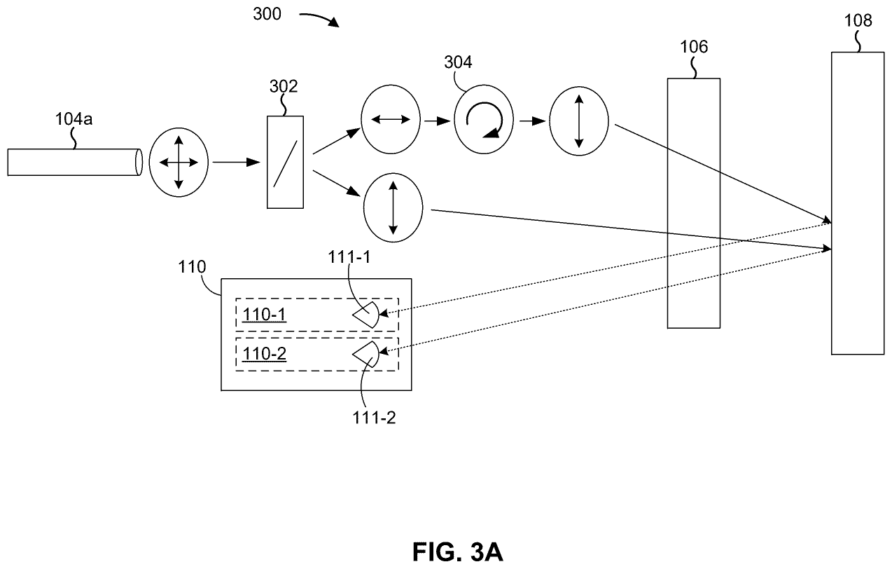

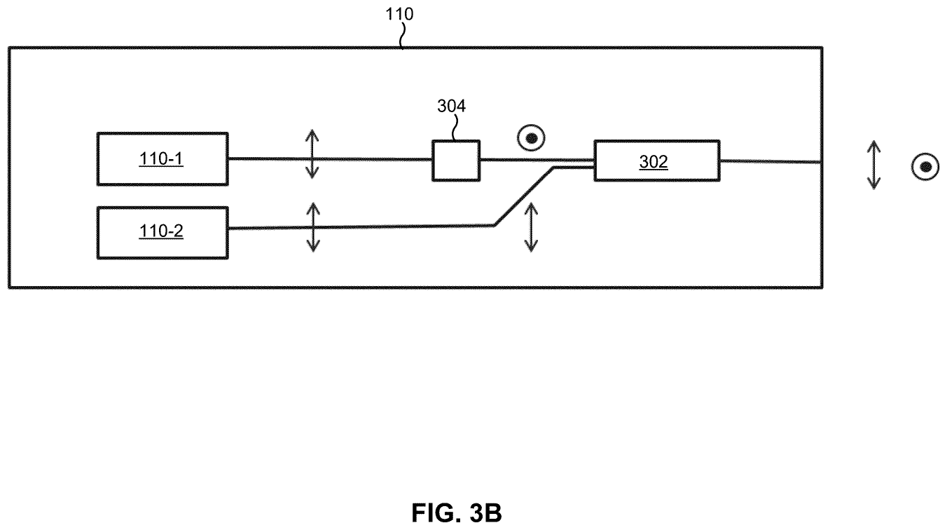

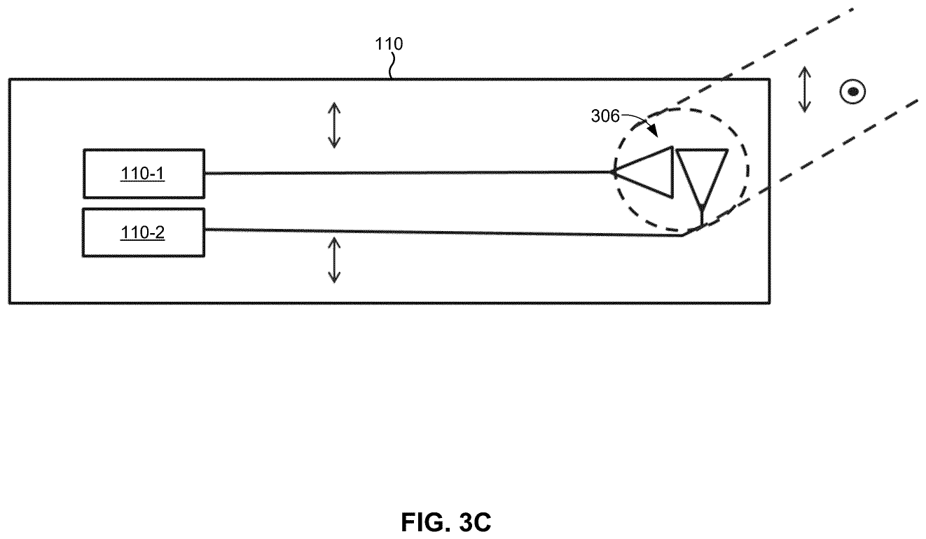

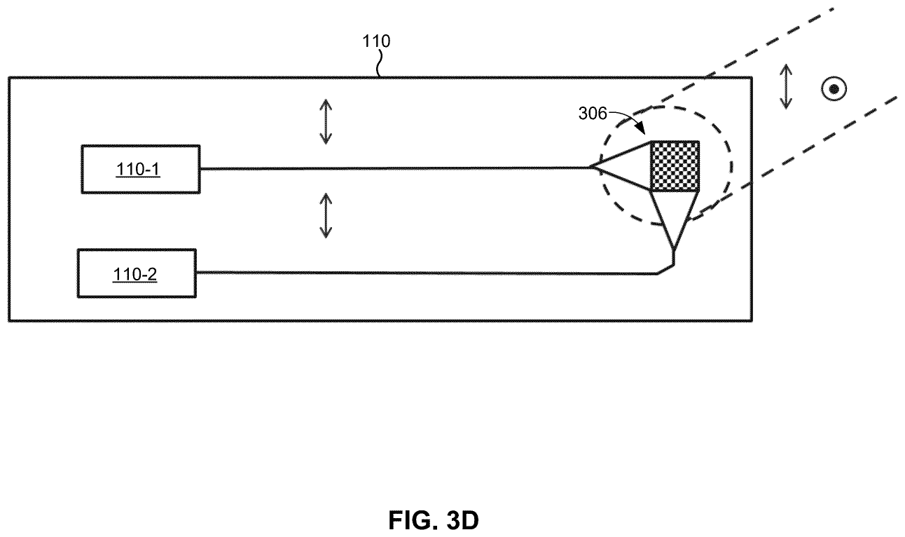

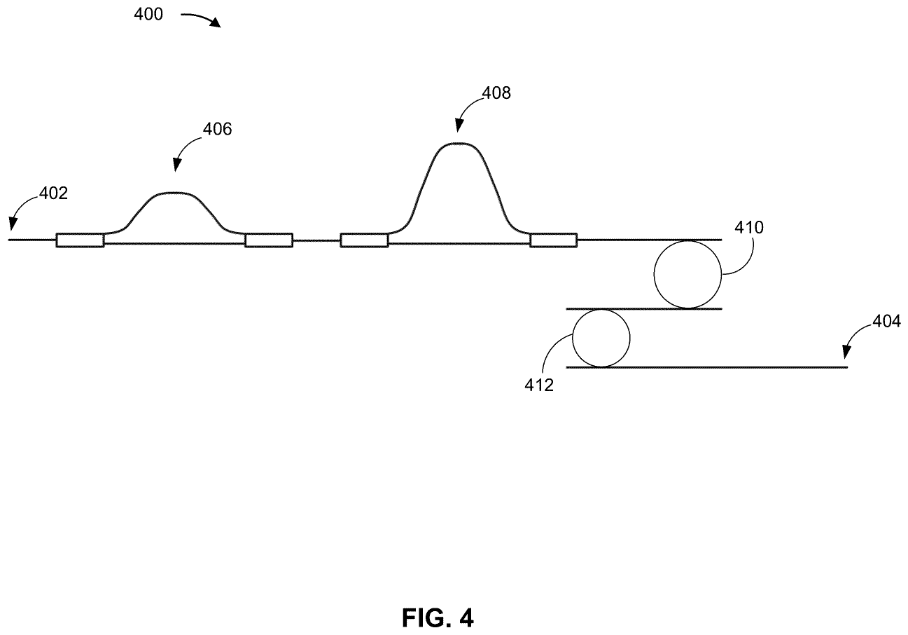

The tunable filter 110 may be optically coupled to the OCM output port 104b (e.g., by an optical fiber). In some implementations, the tunable filter 110 may be in optical paths of subsets of wavelength channels guided by the switching engine 108, as described in connection with FIG. 3A. The tunable filter 110 may provide filtering of wavelength channels that are guided to the tunable filter 110 (e.g., via the OCM output port 104b). For example, the tunable filter 110 may filter particular wavelength channels while allowing one or more other wavelength channels to pass. Moreover, the wavelength channels that are filtered and passed by the tunable filter 110 may be controlled dynamically (e.g., by thermal tuning). The tunable filter 110 may be a SiP filter. In some implementations, the SiP filter may be a ring filter, such as a Vernier ring filter, as described in connection with FIG. 4.

The tunable filter 110 may scan through or switch between respective wavelength channels (e.g., one at a time) of the subset of wavelength channel(s) that are guided to the tunable filter 110 (e.g., via the OCM output port 104b). For example, the tunable filter 110 may scan through respective wavelength channels of a first subset of wavelength channels (e.g., a first spectrum) guided to the tunable filter 110, and sequentially to scanning through the first subset of wavelength channels, the tunable filter 110 may scan through respective wavelength channels of a second subset of wavelength channels guided to the tunable filter 110. “Scanning” through wavelength channels may refer to passing a first wavelength channel while filtering other wavelength channels during a first time period, passing a second wavelength channel while filtering other wavelength channels during a second subsequent time period, and so forth.

While the switching engine 108 may be able to filter wavelength channels with high precision, the switching engine 108 may be associated with slow switching speeds (e.g., and thus may be low cost and relatively non-complex). Thus, the switching engine 108 may be unable to scan through all dispersed wavelength channels in an allotted time (e.g., less than 1 second). For example, an update rate of the switching engine 108 may be 60 hertz or less. Inversely, the tunable filter 110 may be associated with fast switching speeds (e.g., with update times in a microsecond range), but may have relatively low filtering precision compared to the switching engine 108 (e.g., and thus may be low cost and relatively non-complex). Accordingly, the switching engine 108 can be used to precisely pre-filter the total spectrum into a filtered spectrum that is suitable for the tunable filter 110 to quickly scan without the need for high precision. Thus, combining the precise filtering of the switching engine 108 with the high-speed scanning of the tunable filter 110 achieves an OCM that is precise, fast, and low cost.

In an allotted scan time, the switching engine 108 may produce M filtered spectra, where M is greater than or equal to 2 (e.g., where an upper bound of M is a function of a switching speed of the switching engine 108 and the allotted scan time). For example, as described above, the switching engine 108 may produce two interleaved spectra (M=2) in an allotted time. However, if the switching engine 108 has an update rate of 60 hertz, in an allotted scan time of 500 milliseconds (ms), the switching engine 108 may produce up to 30 sub-divided spectra (M=30). The tunable filter 110 may scan through a spectrum (or through relevant portions of the spectrum) in a time between spectra updates of the switching engine 108. For example, with two spectra (M=2) and an allotted scan time of 500 ms, the tunable filter 110 has 250 ms to scan each spectrum. As another example, with 30 spectra (M=30) and an allotted scan time of 500 ms, the tunable filter 110 has about 16 ms to scan each spectrum.

The monitoring element 112 may include one or more photodetectors 114 (e.g., photodiodes or the like) and a signal processing unit 116. The signal processing unit 116 may include one or more analog to digital converters (ADCs) and/or a digital signal processor, among other examples. The monitoring element 112 may monitor the respective wavelength channels output by the tunable filter 110. For example, the monitoring element 112 may detect each wavelength channel output by the tunable filter 110, convert the wavelength channel to an electrical signal, and/or convert the electrical signal to a digital signal, among other examples. An output of the monitoring element 112 may be provided to an analysis component (e.g., a computing device, a processor, or the like) configured to measure characteristics of each wavelength channel based on the output. In some implementations, the tunable filter 110 and/or the monitoring element 112 may be integrated in a SiP chip.

As indicated above, FIG. 1 is provided as an example. Other examples may differ from what is described with regard to FIG. 1.

FIG. 2 is a diagram illustrating an example of the optical device 100. The example of FIG. 2 is a modified implementation of the optical device 100 described in FIG. 1. As shown in FIG. 2, the OCM port group 104 may include multiple OCM input ports 104a, shown as OCM input ports 1 through N, where N is an integer greater than or equal to 2. Each OCM input port 104a may be tapped to a respective location in an optical network, thereby facilitating monitoring of different locations in the optical network.

Each OCM input port 104a may launch an OCM optical signal, as described herein. The switching engine 108 may guide filtered subsets of wavelength channels of each OCM optical signal in sequence. For example, the switching engine 108 may guide filtered subsets of wavelength channels of a first OCM optical signal from a first OCM input port 104a to the OCM output port 104b, the switching engine 108 may then guide filtered subsets of wavelength channels of a second OCM optical signal from a second OCM input port 104a to the OCM output port 104b, and so forth. In this way, the switching engine 108 may operate as a port switch to scan multiple separate spectra.

As indicated above, FIG. 2 is provided as an example. Other examples may differ from what is described with regard to FIG. 2.

FIG. 3A is a diagram illustrating an example optics system 300 that can be used in an optical device, such as optical device 100. The optics system 300 may include a polarization splitter 302 and a polarization rotator 304. The optics system 300 may be positioned in an optical path of an OCM optical signal launched from an OCM input port 104a. For example, the polarization splitter 302 and the polarization rotator 304 may be positioned between the OCM input port 104a and the dispersive element 106.

As shown, an OCM optical signal launched from an OCM input port 104a may have diverse polarization. Generally, SiP devices do not propagate well transverse magnetic (TM) mode light, thereby affecting polarization diversity in the OCM. In addition, some types of switching engines, such as those employing liquid crystals, may function only for one polarization. However, many applications may call for monitoring both the transverse electric (TE) polarization and the TM polarization of the OCM optical signal.

The polarization splitter 302 may split the OCM optical signal into a first signal having a first polarization (e.g., one of a TE polarization or a TM polarization) and a second signal having a second polarization (e.g., the other of the TE polarization or the TM polarization). The polarization rotator 304 may rotate a polarization of the first signal or the second signal. For example, the polarization rotator 304 may rotate the polarization of the first signal or the second signal so that the first signal and the second signal have the same polarization (e.g., the TE polarization). The first signal and the second signal may travel in respective paths through the dispersive element 106 (e.g., producing dispersed wavelength channels) to the switching engine 108, and the first signal and the second signal may be imaged separately onto the tunable filter 110.

The tunable filter 110 may include a first tunable filter component 110-1 (e.g., a first tunable filter) and a second tunable filter component 110-2 (e.g., a second tunable filter). Moreover, the tunable filter 110 may include a first surface coupler 111-1 for (e.g., coupled to) the first tunable filter component 110-1 and a second surface coupler 111-2 for (e.g., coupled to) the second tunable filter component 110-2. The switching engine 108 may guide a filtered subset of wavelength channels of the first signal (in a similar manner as described in connection with FIG. 1) to the first tunable filter component 110-1 via the first surface coupler 111-1. Moreover, the switching engine 108 may guide the filtered subset of wavelength channels of the second signal (e.g., the same subset of wavelength channels as guided for the first signal) to the second tunable filter component 110-2 via the second surface coupler 111-2. Thus, in this configuration, the tunable filter 110 may be part of the free-space optics of the optics device 100. By guiding the two polarizations directly to the first surface coupler 111-1 and the second surface coupler 111-2, respectively, the example of FIG. 3A takes advantage of the polarization splitting that enables the switching engine 108 to operate on both polarizations, such that the additional steps of recombining the polarizations and then again separating the polarizations for the tunable filter 110 can be eliminated.

The first tunable filter component 110-1 may scan through respective wavelength channels of the filtered subset of wavelength channels of the first signal, and the second tunable filter component 110-2 may scan (e.g., separately) through respective wavelength channels of the filtered subset of wavelength channels of the second signal. One or more monitoring elements 112 (not shown in FIG. 3A) may monitor the respective wavelength channels output by each of the first tunable filter component 110-1 and the second tunable filter component 110-2, in a similar manner as described in connection with FIG. 1. In some implementations, the first polarization and the second polarization may be recombined in a digital domain (e.g., at the one or more monitoring elements 112).

As indicated above, FIG. 3A is provided as an example. Other examples may differ from what is described with regard to FIG. 3A.

FIGS. 3B-3D are diagrams illustrating example tunable filters 110. The tunable filters 110 of FIGS. 3B-3D include polarization splitting and rotation functionality (e.g., on chip), rather than in the optics system 300, as described in connection with FIG. 3A.

FIG. 3B shows a tunable filter 110 in an edge-coupled configuration. As shown in FIG. 3B, light from the switching engine 108 (e.g., from a free space section) may be coupled directly into the tunable filter 110 (e.g., into the tunable filter chip) via a lens or an optical fiber that is coupled to the tunable filter 110. The tunable filter 110 may include the polarization splitter 302 and the polarization rotator 304. In this way, the first tunable filter component 110-1 and the second tunable filter component 110-2 may use only a single polarization state.

FIG. 3C shows a tunable filter 110 in a surface grating coupler configuration. Surface gratings 306 can diffract and focus a beam incident on a top surface of the tunable filter 110 (e.g., the tunable filter chip) into a single mode waveguide. Due to geometry, only light initially polarized perpendicular to the output waveguide will be diffracted. Thus, a single grating 306 acts as a polarizer. A second grating 306 arranged orthogonal to the first grating 306 and positioned in the beam spot will couple the opposite polarization to the first grating 306.

FIG. 3D shows a tunable filter 110 in a dual polarization grating configuration. As shown in FIG. 3D, the gratings 306 may be super-imposed on one another to make a two-dimensional grating. In this way, coupling efficiency is improved by positioning each grating 306 at a center of the beam spot.

As indicated above, FIGS. 3B-3D are provided as examples. Other examples may differ from what is described with regard to FIGS. 3B-3D.

FIG. 4 is a diagram illustrating an example ring filter 400. The ring filter 400 may correspond to the tunable filter 110 and/or a tunable filter component 110-1, 110-2. The ring filter 400 may be a Vernier ring filter.

As shown, the ring filter 400 may include an input 402 and an output 404 that define a direction of light propagation. The ring filter 400 may include a first band-select Mach-Zehnder interferometer 406 and a second band-select Mach-Zehnder interferometer 408 coupled to an output of the first band-select Mach-Zehnder interferometer 406. Furthermore, the ring filter 400 may include a first Vernier ring 410 coupled to an output of the second band-select Mach-Zehnder interferometer 408, and a second Vernier ring 412 coupled to an output of the first Vernier ring 410. The ring filter 400 may include one or more heating elements (not shown) that are configured to heat the Vernier rings 410, 412 to different temperatures, thereby altering the wavelengths filtered by the Vernier rings 410, 412.

In some implementations, the tunable filter 110 may include a chain of Mach-Zehnder interferometers, each having different length delay arms, that synthesizes a bandpass filter. Tuning may be performed through heating elements on the delay arms. In some implementations, the tunable filter 110 may include a ring coupled to input and output bus waveguides that provides a narrow bandpass filter. Tuning may be performed through a heating element on the ring section. The filter may be periodic in optical frequency with a period F of the free-spectral range (FSR). If the FSR is wide enough such that free-space wavelength selection elements (e.g., the dispersive element 106 and the switching engine 108) can remove unwanted wavelengths from a current scan region, then a single ring may be used. Sharper filtering may be achieved by using multiple (e.g., two) rings to produce a higher-order filter. The FSR of two rings may be offset by a small amount, F2=F1−df, to increase the effective FSR to F1×F2/df (Vernier effect). This relaxes a pre-filtering requirement on the free-space wavelength selection. In some implementations, two or more ring filters with different FSRs may be placed in series (e.g., cascaded rings) to narrow the bandpass and increase the overall FSR by the Vernier effect. The ring filters may be single ring filters, or multi-ring filters, in series. In some implementations, the tunable filter 110 may employ a combination of Mach-Zehnder interferometers and rings. For example, Mach-Zehnder filters may be used to eliminate unwanted transmission passbands of the periodic ring filters. Here, the ring filters may provide fine wavelength filtering, and the Mach-Zehnder filters may provide a coarse blocking function.

As indicated above, FIG. 4 is provided as an example. Other examples may differ from what is described with regard to FIG. 4.

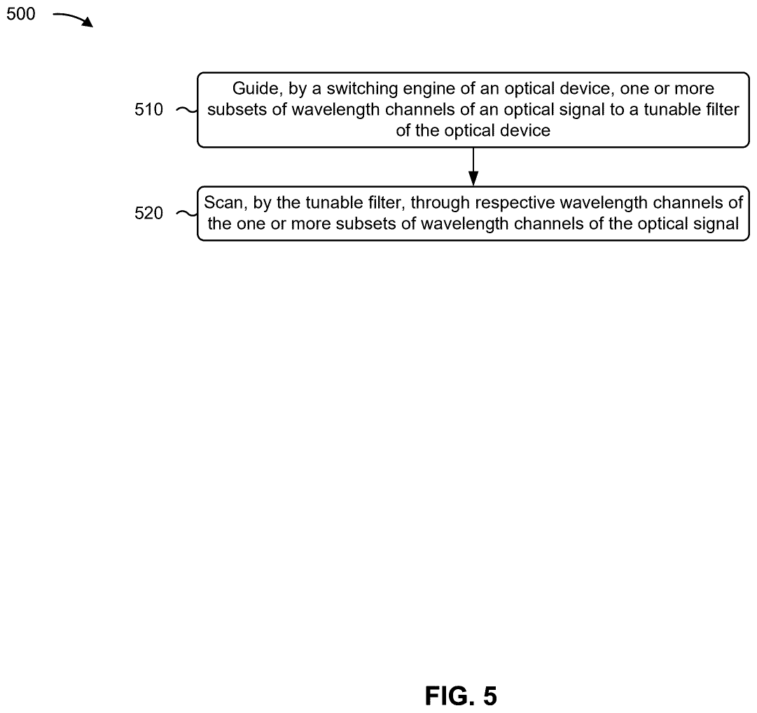

FIG. 5 is a flowchart of an example process 500 associated with optical channel monitoring. In some implementations, one or more process blocks of FIG. 5 are performed by an optical device (e.g., optical device 100).

As shown in FIG. 5, process 500 may include guiding, by a switching engine of the optical device, one or more subsets of wavelength channels of an optical signal to a tunable filter of the optical device (block 510). In some implementations, guiding the one or more subsets of wavelength channels of the optical signal includes sequentially: guiding a first subset of wavelength channels of the optical signal to the tunable filter while blocking a second subset of wavelength channels of the optical signal, and guiding the second subset of wavelength channels of the optical signal to the tunable filter while blocking the first subset of wavelength channels of the optical signal. In some implementations, the one or more subsets of wavelength channels comprises two or more interleave spectra.

As further shown in FIG. 5, process 500 may include scanning, by the tunable filter, through respective wavelength channels of the one or more subsets of wavelength channels of the optical signal (block 520). In some implementations, scanning through the respective wavelength channels comprises sequentially: scanning through the respective wavelength channels of the first subset of wavelength channels of the optical signal, and scanning through the respective wavelength channels of the second subset of wavelength channels of the optical signal. In some implementations, process 500 includes measuring the respective wavelength channels output by the tunable filter.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be designed to implement the systems and/or methods based on the description herein. Use of the term “sequentially” and its derivatives is merely meant to indicate that a second condition or operation follows a first condition or operation at a later time period. It is not intended to preclude other intervening or recurring conditions or operations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical device combining a wavelength selective switch and an optical channel monitor, comprising:
a first port group, for wavelength-division switching, comprising a first input port to launch a first optical signal;
a second port group, for optical channel monitoring, comprising a second input port to launch a second optical signal;
a dispersive element positioned in optical paths of the first optical signal and the second optical signal, the dispersive element to separate the first optical signal and the second optical signal into dispersed wavelength channels;
a switching engine positioned in optical paths of the dispersed wavelength channels, the switching engine to:
guide one or more wavelength channels of the first optical signal to respective output ports of the first port group, and
guide one or more subsets of wavelength channels of the second optical signal to an output port of the second port group; and
a tunable filter to scan through respective wavelength channels of the one or more subsets of wavelength channels of the second optical signal.

2. The optical device of claim 1, wherein the switching engine, to guide the one or more subsets of wavelength channels of the second optical signal, is to sequentially:
guide a first subset of wavelength channels of the second optical signal to the output port of the second port group, while blocking a second subset of wavelength channels of the second optical signal; and
guide the second subset of wavelength channels of the second optical signal to the output port of the second port group, while blocking the first subset of wavelength channels of the second optical signal,
wherein the first subset of wavelength channels is different from the second subset of wavelength channels.

3. The optical device of claim 2, wherein the first subset of wavelength channels has no common wavelength channels with the second subset of wavelength channels.

4. The optical device of claim 1, wherein the one or more subsets of wavelength channels comprises two or more interleave spectra.

5. The optical device of claim 1, wherein the second input port is one of a plurality of second input ports of the second port group.

6. The optical device of claim 1, wherein the switching engine comprises a digital light processor switching engine, a liquid crystal on silicon switching engine, or a micro-electrical-mechanical mirrors system switching engine.

7. The optical device of claim 1, further comprising:
a monitoring element to measure the respective wavelength channels output by the tunable filter, the monitoring element comprising one or more photodetectors and a signal processing unit.

8. The optical device of claim 7, wherein the tunable filter and the monitoring element are integrated in a silicon photonics chip.

9. An optical channel monitor, comprising:
a dispersive element positioned in an optical path of an optical signal, the dispersive element to separate the optical signal into dispersed wavelength channels;
a switching engine positioned in optical paths of the dispersed wavelength channels, the switching engine to guide one or more subsets of wavelength channels of the optical signal; and
a tunable filter to scan through respective wavelength channels of the one or more subsets of wavelength channels of the optical signal.

10. The optical channel monitor of claim 9, further comprising:
a polarization splitter to split the optical signal into a first signal having a first polarization and a second signal having a second polarization; and
a polarization rotator to rotate a polarization of the first signal or the second signal,
wherein the tunable filter comprises a first tunable filter component and a second tunable filter component, and
wherein the switching engine is to guide a subset of wavelength channels of the first signal to a first surface coupler of the tunable filter for the first tunable filter component, and to guide the subset of wavelength channels of the second signal to a second surface coupler of the tunable filter for the second tunable filter component.

11. The optical channel monitor of claim 9, wherein the switching engine, to guide the one or more subsets of wavelength channels of the optical signal, is to sequentially:
guide a first subset of wavelength channels of the optical signal, while blocking a second subset of wavelength channels of the optical signal; and
guide the second subset of wavelength channels of the optical signal, while blocking the first subset of wavelength channels of the optical signal,
wherein the first subset of wavelength channels is different from the second subset of wavelength channels.

12. The optical channel monitor of claim 9, wherein the tunable filter is integrated in a silicon photonics chip.

13. The optical channel monitor of claim 9, further comprising:
a monitoring element to measure the respective wavelength channels output by the tunable filter, the monitoring element comprising one or more photodetectors and a signal processing unit.

14. The optical channel monitor of claim 9, wherein the switching engine comprises a digital light processor switching engine, a liquid crystal on silicon switching engine, or a micro-electrical-mechanical mirrors system switching engine.

15. The optical channel monitor of claim 9, wherein the one or more subsets of wavelength channels comprises two or more interleave spectra.

16. A method, comprising:
guiding, by a switching engine of an optical device, one or more subsets of wavelength channels of an optical signal to a tunable filter of the optical device; and
scanning, by the tunable filter, through respective wavelength channels of the one or more subsets of wavelength channels of the optical signal.

17. The method of claim 16, wherein guiding the one or more subsets of wavelength channels of the optical signal comprises sequentially:
guiding a first subset of wavelength channels of the optical signal to the tunable filter, while blocking a second subset of wavelength channels of the optical signal; and
guiding the second subset of wavelength channels of the optical signal to the tunable filter, while blocking the first subset of wavelength channels of the optical signal.

18. The method of claim 17, wherein scanning through the respective wavelength channels comprises sequentially:
scanning through the respective wavelength channels of the first subset of wavelength channels of the optical signal; and
scanning through the respective wavelength channels of the second subset of wavelength channels of the optical signal.

19. The method of claim 16, further comprising:
measuring the respective wavelength channels output by the tunable filter.

20. The method of claim 16, wherein the one or more subsets of wavelength channels comprises two or more interleave spectra.
